(19) United States
(12) Patent Application Publication
(10) Pub. No.: US 2025/0088792 A1
(43) Pub. Date: Mar. 13, 2025

(54) WEARABLE ELECTRONIC DEVICE

(71) Applicant: SAMSUNG ELECTRONICS CO., LTD., Suwon-si (KR)

(72) Inventors: Jinyong Kim, Suwon-si (KR); Jonghwan Kim, Suwon-si (KR); Taiyong Kim, Suwon-si (KR); Wonju Seo, Suwon-si (KR); Myungcheol Lee, Suwon-si (KR); Yonghoon Lee, Suwon-si (KR); Jeock Lee, Suwon-si (KR)

(73) Assignee: SAMSUNG ELECTRONICS CO., LTD., Suwon-si (KR)

(21) Appl. No.: 18/958,491

(22) Filed: Nov. 25, 2024

Related U.S. Application Data
(63) Continuation of application No. PCT/KR2023/005915, filed on Apr. 28, 2023.

(30) Foreign Application Priority Data
May 27, 2022 (KR) 10-2022-0065546
Jul. 26, 2022 (KR) 10-2022-0092291

(51) Int. Cl. H04R 1/34; H04R 1/02; H04R 1/10

(52) U.S. Cl. CPC H04R 1/345; H04R 1/023; H04R 1/1016; H04R 1/1058

(57) ABSTRACT

Provided is a wearable electronic device including: a housing forming at least a part of an exterior of the wearable electronic device; a nozzle extending from a part of the housing, wherein the nozzle includes a first hole at a first position and a second hole at a second position; an acoustic path inside the nozzle; a grill inside the nozzle, wherein the grill includes a first latch passing through the first hole such that a part thereof protrudes in a first direction and a second latch passing through the second hole such that a part thereof protrudes in a second direction; and an ear tip at least partially surrounding an outer surface of the nozzle, wherein the ear tip includes a first groove detachably coupled to a part of the first latch and a second groove detachably coupled to a part of the second latch.

### CROSS-REFERENCE TO RELATED APPLICATIONS

This application is a by-pass continuation of International Application No. PCT/KR2023/005915, filed on Apr. 28, 2023, which is based on and claims priority to Korean Patent Application No. 10-2022-0065546, filed in the Korean Intellectual Property Office on May 27, 2022, Korean Patent Application No. 10-2022-0092291, filed in the Korean Intellectual Property Office on Jul. 26, 2022, the disclosures of which are incorporated by reference herein in their entireties.

### BACKGROUND

### 1. Field

The present disclosure relates to an electronic device that is wearable on a user's ear.

### 2. Description of Related Art

With the development of digital technology, electronic devices are provided in various forms, such as smartphones, a tablet personal computers (PCs), or personal digital assistants (PDAs) in a bar, foldable, rollable, or sliding type.

The electronic device of the present disclosure is being developed in the form of a wearable electronic device, which is wearable on a user's ear, to improve portability and accessibility.

For example, the wearable electronic device may include a canal type of earphone or an in-ear type of earphone that a user may wear in the ear.

A wearable electronic device (e.g., earphone) may be used by being worn in a user's ear (e.g., external auditory meatus).

Such wearable electronic devices may receive voice and/or sound from the outside and/or output sound to the outside using a microphone module and a speaker module. For example, the wearable electronic device may process voice and/or sound input through the microphone into an electrical signal and convert the electrical signal into a sound signal through the speaker module for output.

The wearable electronic device may include an ear tip that separates an external space from an eardrum of a person and a nozzle that forms an acoustic path. The ear tip and the nozzle may be attachably/detachably coupled using a convex-concave structure (e.g., concave and convex portions).

When a convex-concave structure is formed in the nozzle, the width inside the nozzle narrows and the acoustic path may be reduced. As the width inside the nozzle narrows and the acoustic path is reduced, the sound and/or sound quality output from the wearable electronic device may be degraded.

### SUMMARY

Provided is a wearable electronic device that is capable of ensuring a wide acoustic path without reducing the acoustic path.

According to an aspect of the disclosure, a wearable electronic device includes: a housing forming at least a part of an exterior of the wearable electronic device; a nozzle extending from a part of the housing, wherein the nozzle includes a first hole at a first position and a second hole at a second position; an acoustic path inside the nozzle; a grill inside the nozzle, wherein the grill includes a first latch passing through the first hole such that a part thereof protrudes in a first direction and a second latch passing through the second hole such that a part thereof protrudes in a second direction; and an ear tip at least partially surrounding an outer surface of the nozzle, wherein the ear tip includes a first groove detachably coupled to a part of the first latch and a second groove detachably coupled to a part of the second latch.

The nozzle may further include a first concave portion at a third position between the first hole and the second hole and a second concave portion at a fourth position between the first hole and the second hole, and the grill may further include a first coupling member detachably coupled to the first concave portion and a second coupling member detachably coupled to the second concave portion.

The first hole and the second hole may face each other, and the first concave portion and the second concave portion may face each other.

The first coupling member may include a first through-hole, and the second coupling member may include a second through-hole.

The ear tip may include a third through-hole in a part of the ear tip corresponding to the first through-hole, and a fourth through-hole in a part of the ear tip corresponding to the second through-hole.

The first through-hole, the second through-hole, the third through-hole, and the fourth through-hole may be in communication with the acoustic path.

The grill may further include: a frame disposed across one end of the nozzle and including at least one opening; a first extension extending from a first portion of the frame and integrally connected to the first latch; and a second extension extending from a second portion of the frame and integrally connected to the second latch.

The grill may further include: a third extension extending from a third portion of the frame and integrally connected to the first coupling member; and a fourth extension extending from a fourth portion of the frame and integrally connected to the second coupling member.

The first latch may include a first inclined surface, the second latch may include a second inclined surface, the first groove may include a third inclined surface, and the second groove may include a fourth inclined surface, and the first latch may be at least partially coupled to the first groove, and the second latch may be at least partially coupled to the second groove.

A sealing member may be partially formed at an end of the ear tip that faces a part of the housing.

An insertion guide may be formed on a part of an inner side of the ear tip.

The insertion guide may include a first cutting portion on a part of an inner side surface of the ear tip in the first direction and a second cutting portion on a part of the inner side surface of the ear tip in the second direction.

The part of the ear tip on which the first cutting portion is formed may include an upper portion having a width that is narrower than a width of a lower portion of the part of the ear tip on which the first cutting portion is formed.

The first extension may be bent toward an inner side of the frame when the first latch is under pressure from the ear tip and may be restored to an original position when the first latch is not under pressure from the ear tip, and the second extension may be bent toward the inner side of the frame when the second latch is under pressure from the ear tip and may be restored to an original position when the second latch is not under pressure from the ear tip.

At least one guide groove may be formed on the inner side of the nozzle, and the at least one guide groove may be configured to guide a part of the grill to be inserted into the nozzle.

According to an aspect of the disclosure, a wearable electronic device includes: a housing forming at least a part of an exterior of the wearable electronic device; a nozzle extending from a part of the housing, wherein the nozzle includes a hole in a side surface of the nozzle; a grill inside the nozzle, wherein the grill includes a latch passing through the hole such that a part thereof protrudes out of the nozzle through the hole; and an ear tip at least partially surrounding an outer surface of the nozzle, wherein the ear tip includes a groove coupled to a part of the latch.

The nozzle may be configured to receive the grill through an acoustic path formed by an interior of the nozzle during assembly of the wearable electronic device.

The ear tip may be configured to alternately attach or detach from the nozzle.

The grill may further include: a frame disposed across one end of the nozzle and including at least one opening; and a first extension extending from the frame and integrally connected to the latch.

A sealing member may be partially formed at an end of the ear tip that faces a part of the housing.

According to one or more embodiments of the present disclosure, the coupling structure of the ear tip and the nozzle may be simplified using a grille, and a wide acoustic path may be ensured inside the nozzle, thereby improving the high bandwidth sound and/or sound quality output from the wearable electronic device.

In addition, various effects that can be directly or indirectly identified through the present document may be provided.

### BRIEF DESCRIPTION OF THE DRAWINGS

The above and other aspects and features of certain embodiments of the present disclosure will be more apparent from the following description taken in conjunction with the accompanying drawings, in which:

FIG. 1 is a block diagram of an electronic device in a network environment according to one or more embodiments of the present disclosure;

FIG. 2 is a block diagram of an audio module according to one or more embodiments of the present disclosure;

FIG. 3 is a view schematically illustrating a wearable electronic device according to one or more embodiments of the present disclosure;

FIG. 4 is a view schematically illustrating a nozzle of a wearable electronic device according to one or more embodiments of the present disclosure;

FIG. 5 is a view schematically illustrating a grill of a wearable electronic device according to one or more embodiments of the present disclosure;

FIG. 6 is a view schematically illustrating an ear tip of a wearable electronic device according to one or more embodiments of the present disclosure;

FIG. 7 is a view schematically illustrating a state before an ear tip of a wearable electronic device, according to one or more embodiments of the present disclosure, is inserted into a nozzle;

FIG. 8 is a view schematically illustrating an intermediate state in which an ear tip of a wearable electronic device, according to one or more embodiments of the present disclosure, is inserted into a nozzle;

FIG. 9 is a view schematically illustrating the state after an ear tip of a wearable electronic device, according to one or more embodiments of the present disclosure, has been inserted into a nozzle;

FIG. 10 is a view schematically illustrating a state in which a grill, a nozzle, and an ear tip of a wearable electronic device, according to one or more embodiments of the present disclosure, are coupled together;

FIG. 11 is a view schematically illustrating an embodiment in which a through-hole is formed in a first coupling member and/or a second coupling member of a wearable electronic device according to one or more embodiments of the present disclosure;

FIG. 12 is a view schematically illustrating an embodiment in which a through-hole is formed in an ear tip corresponding to a through-hole formed in a first coupling member and/or a second coupling member of a wearable electronic device according to one or more embodiments of the present disclosure;

FIG. 13 is a view in which a portion corresponding to the through-hole of the wearable electronic device disclosed in FIG. 12 is cut in a horizontal direction and viewed from the z-axis; and

FIG. 14 is a view schematically illustrating an example of a guide groove formed on an inner side of a nozzle of a wearable electronic device according to one or more embodiments of the present disclosure.

### DETAILED DISCLOSURE

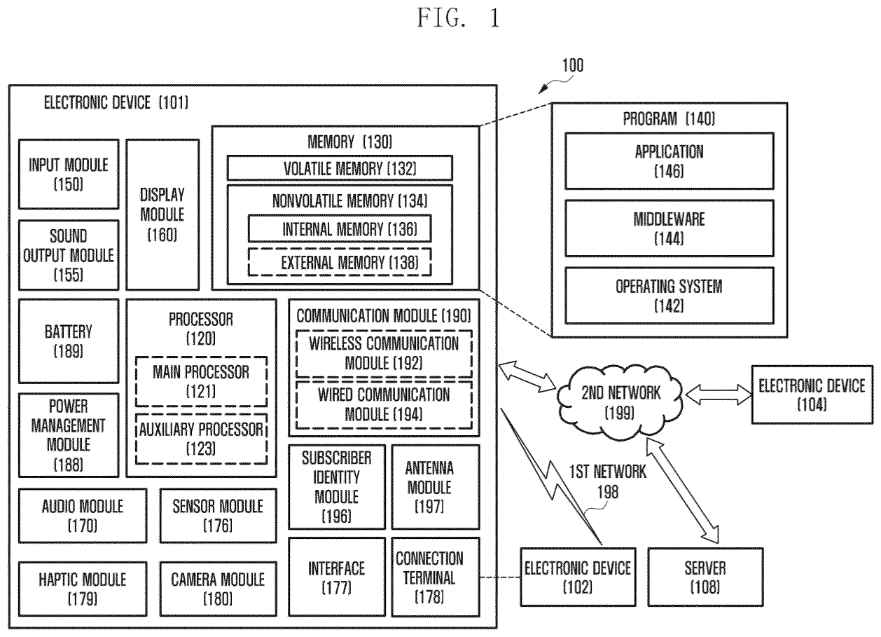

FIG. 1 is a block diagram illustrating an electronic device 101 in a network environment 100 according to one or more embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In one or more embodiments, at least one of the components (e.g., the connecting terminal 178) may be omitted from the electronic device 101, or one or more other components may be added in the electronic device 101. In one or more embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one or more embodiments, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one or more embodiments, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196. The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197. The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to one or more embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology. According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

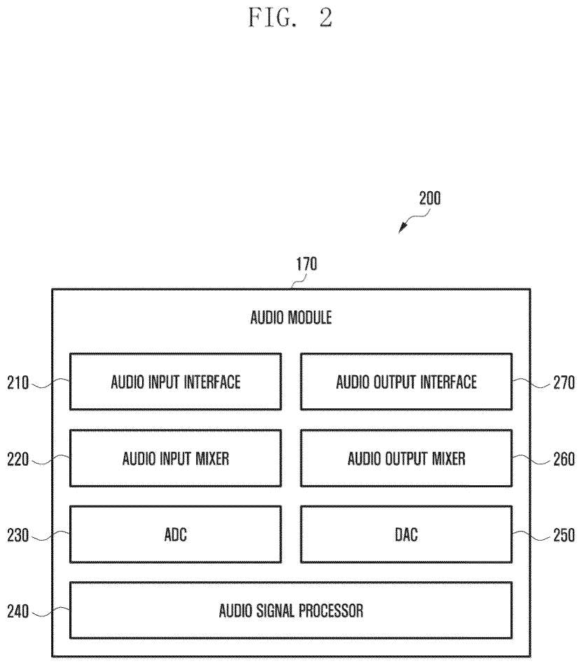

FIG. 2 is a block diagram 200 illustrating the audio module 170 according to one or more embodiments. Referring to FIG. 2, the audio module 170 may include, for example, an audio input interface 210, an audio input mixer 220, an analog-to-digital converter (ADC) 230, an audio signal processor 240, a digital-to-analog converter (DAC) 250, an audio output mixer 260, or an audio output interface 270.

The audio input interface 210 may receive an audio signal corresponding to a sound obtained from the outside of the electronic device 101 via a microphone (e.g., a dynamic microphone, a condenser microphone, or a piezo microphone) that is configured as part of the input module 150 or separately from the electronic device 101. For example, if an audio signal is obtained from the external electronic device 102 (e.g., a headset or a microphone), the audio input interface 210 may be connected with the external electronic device 102 directly via the connecting terminal 178, or wirelessly (e.g., Bluetooth™ communication) via the wireless communication module 192 to receive the audio signal. According to an embodiment, the audio input interface 210 may receive a control signal (e.g., a volume adjustment signal received via an input button) related to the audio signal obtained from the external electronic device 102. The audio input interface 210 may include a plurality of audio input channels and may receive a different audio signal via a corresponding one of the plurality of audio input channels, respectively. According to an embodiment, additionally or alternatively, the audio input interface 210 may receive an audio signal from another component (e.g., the processor 120 or the memory 130) of the electronic device 101.

The audio input mixer 220 may synthesize a plurality of inputted audio signals into at least one audio signal. For example, according to an embodiment, the audio input mixer 220 may synthesize a plurality of analog audio signals inputted via the audio input interface 210 into at least one analog audio signal.

The ADC 230 may convert an analog audio signal into a digital audio signal. For example, according to an embodiment, the ADC 230 may convert an analog audio signal received via the audio input interface 210 or, additionally or alternatively, an analog audio signal synthesized via the audio input mixer 220 into a digital audio signal.

The audio signal processor 240 may perform various processing on a digital audio signal received via the ADC 230 or a digital audio signal received from another component of the electronic device 101. For example, according to an embodiment, the audio signal processor 240 may perform changing a sampling rate, applying one or more filters, interpolation processing, amplifying or attenuating a whole or partial frequency bandwidth, noise processing (e.g., attenuating noise or echoes), changing channels (e.g., switching between mono and stereo), mixing, or extracting a specified signal for one or more digital audio signals. According to an embodiment, one or more functions of the audio signal processor 240 may be implemented in the form of an equalizer.

The DAC 250 may convert a digital audio signal into an analog audio signal. For example, according to an embodiment, the DAC 250 may convert a digital audio signal processed by the audio signal processor 240 or a digital audio signal obtained from another component (e.g., the processor (120) or the memory (130)) of the electronic device 101 into an analog audio signal.

The audio output mixer 260 may synthesize a plurality of audio signals, which are to be outputted, into at least one audio signal. For example, according to an embodiment, the audio output mixer 260 may synthesize an analog audio signal converted by the DAC 250 and another analog audio signal (e.g., an analog audio signal received via the audio input interface 210) into at least one analog audio signal.

The audio output interface 270 may output an analog audio signal converted by the DAC 250 or, additionally or alternatively, an analog audio signal synthesized by the audio output mixer 260 to the outside of the electronic device 101 via the sound output module 155. The sound output module 155 may include, for example, a speaker, such as a dynamic driver or a balanced armature driver, or a receiver. According to an embodiment, the sound output module 155 may include a plurality of speakers. In such a case, the audio output interface 270 may output audio signals having a plurality of different channels (e.g., stereo channels or 5.1 channels) via at least some of the plurality of speakers. According to an embodiment, the audio output interface 270 may be connected with the external electronic device 102 (e.g., an external speaker or a headset) directly via the connecting terminal 178 or wirelessly via the wireless communication module 192 to output an audio signal.

According to an embodiment, the audio module 170 may generate, without separately including the audio input mixer 220 or the audio output mixer 260, at least one digital audio signal by synthesizing a plurality of digital audio signals using at least one function of the audio signal processor 240.

According to an embodiment, the audio module 170 may include an audio amplifier (e.g., a speaker amplifying circuit) that is capable of amplifying an analog audio signal inputted via the audio input interface 210 or an audio signal that is to be outputted via the audio output interface 270. According to an embodiment, the audio amplifier may be configured as a module separate from the audio module 170.

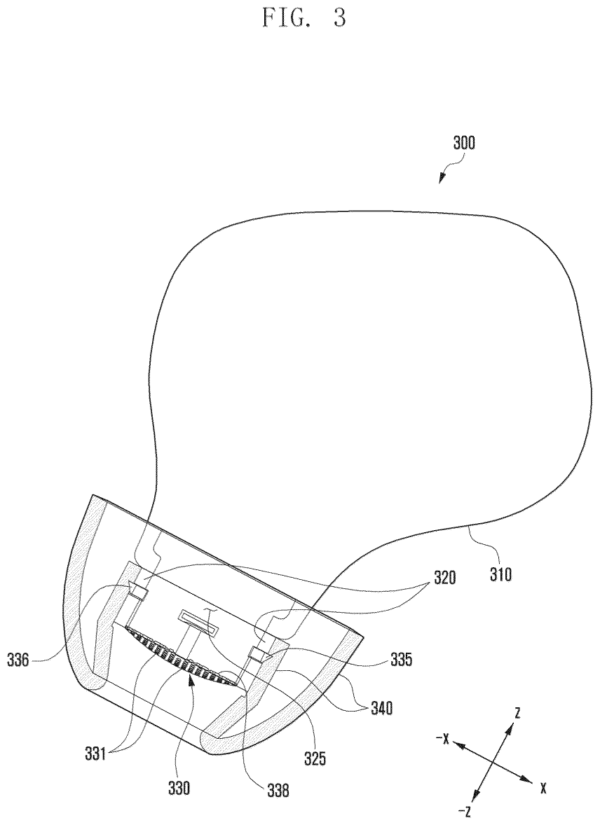

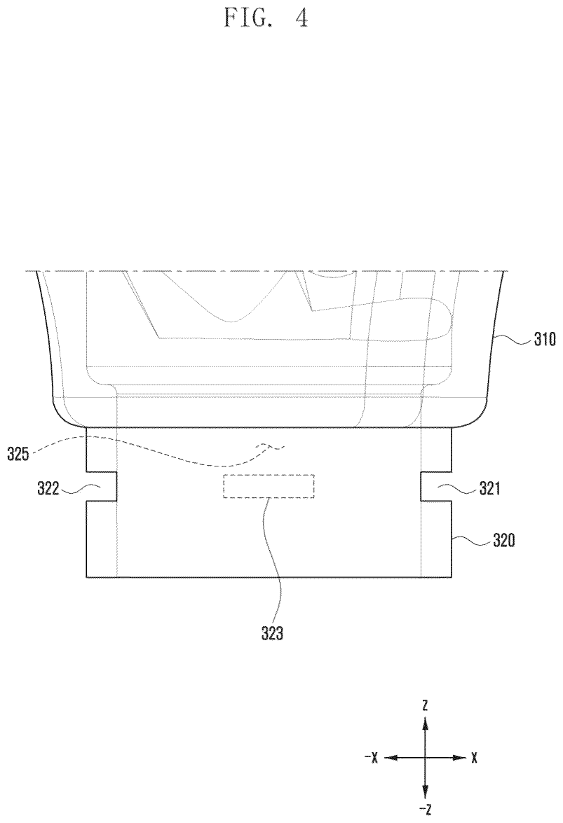

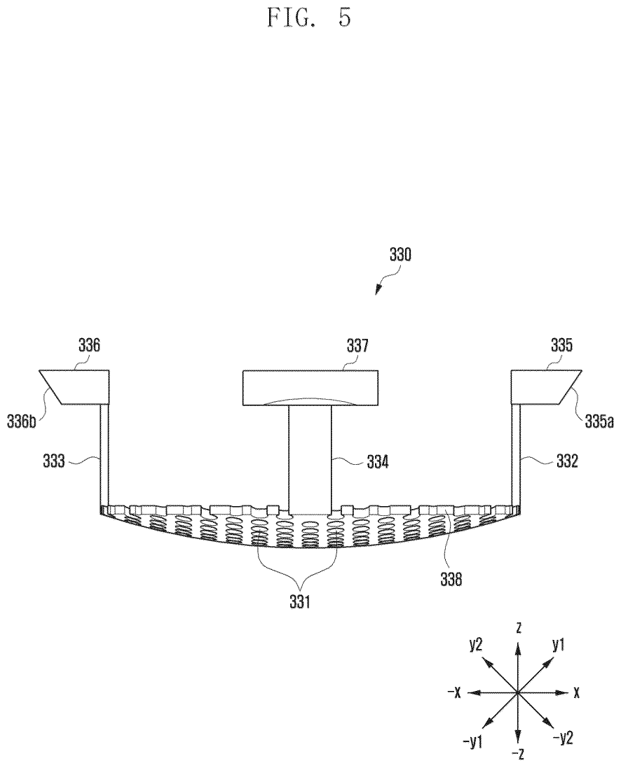

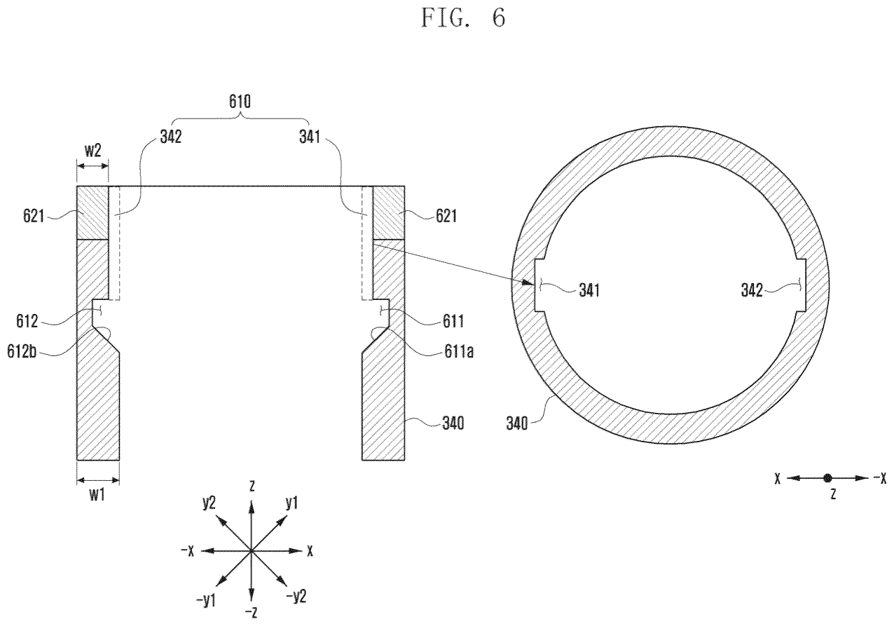

FIG. 3 is a view schematically illustrating a wearable electronic device according to one or more embodiments of the present disclosure. FIG. 4 is a view schematically illustrating a nozzle of a wearable electronic device according to one or more embodiments of the present disclosure. FIG. 5 is a view schematically illustrating a grill of a wearable electronic device according to one or more embodiments of the present disclosure. FIG. 6 is a view schematically illustrating an ear tip of a wearable electronic device according to one or more embodiments of the present disclosure.

According to an embodiment, a wearable electronic device 300 in FIG. 3 may include the constituent elements and embodiments described in the electronic device 101 disclosed in FIG. 1. For example, the wearable electronic device 300 may include the audio module 170 disclosed in FIG. 2.

According to an embodiment, the wearable electronic device 300 may include one of a kernel-type earphone, an in-ear type earphone, an in-ear earset, an in-ear headset, or a hearing aid that is wearable on a user's ear.

According to an embodiment, the wearable electronic device 300 according to an embodiment of the present disclosure is described as an example of a kernel-type or in-ear type wireless earphone, but the disclosure is not limited thereto and may be applied to any wearable electronic device that is wearable on a user's ear.

With reference to FIGS. 3 to 6, the wearable electronic device 300 (e.g., a wireless earphone), according to one or more embodiments of the present disclosure, may include a housing 310, a nozzle 320, an acoustic path 325, a grill 330, and/or an ear tip 340.

According to an embodiment, the housing 310 may form at least a part of the exterior appearance of the wearable electronic device 300. Apart of the housing 310 may be inserted into a user's ear of the wearable electronic device 300. At least a part of the housing 310 may include a shape that is attachable to or dateable from a user's ear (e.g., external auditory meatus) of the wearable electronic device 300. At least a part of the housing 310 may be constituted of various materials, such as a polymer and/or a metal. For example, at least a part of the housing 310 may be constituted of a rigid material.

According to one or more embodiments, the housing 310 may include a microphone module (e.g., the input module 150 in FIG. 1), a speaker module (e.g., the sound output module 155 in FIG. 1), and/or a battery (e.g., the battery 189 in FIG. 1) therein.

According to one or more embodiments, the microphone module (e.g., the input module 150 of FIG. 1) may be disposed on a part inside the acoustic path 325. The microphone module may receive audio (e.g., voice and/or sound) input through at least one opening 331 formed in a frame 338 of the grill 330 and the acoustic path 325 through a microphone hole and convert the audio into an electrical sound signal. The microphone module is an audio input interface (e.g., the audio input interface 210 in FIG. 2), which may include at least one of a dynamic microphone, a condenser microphone, a micro electro mechanical system (MEMS), or a piezo microphone. The microphone module may include a microphone for active noise canceling to eliminate noise within the wearable electronic device 300.

According to one or more embodiments, the speaker module (the sound output module 155 in FIG. 1) may be disposed spaced apart from the microphone module. The speaker module may convert an electrical signal to sound, and transmit the converted sound to an eardrum of a user of the wearable electronic device 300 through at least one opening 331 formed in the acoustic path 325 and the frame 338 of the grill 330. The speaker module may be constituted to allow a user of the wearable electronic device 300 to listen to various sound-related information, such as playable music or playable multimedia.

According to one or more embodiments, the battery (e.g., the battery 189 in FIG. 1) may supply power to at least one constituent element of the wearable electronic device 300 (e.g., the microphone module and/or the speaker module). The battery may include, for example, a rechargeable secondary cell.

According to an embodiment, the nozzle 320 may be integrally formed with a part of the housing 310. The nozzle 320 may be formed to extend (or protrude) from a part of the housing 310 in a designated direction (e.g., in the −z-axis direction). The nozzle 320 may be constituted as a part of the housing 310. At least a part of the nozzle 320 may be inserted into a user's ear (e.g., external auditory meatus) of the wearable electronic device 300 and worn.

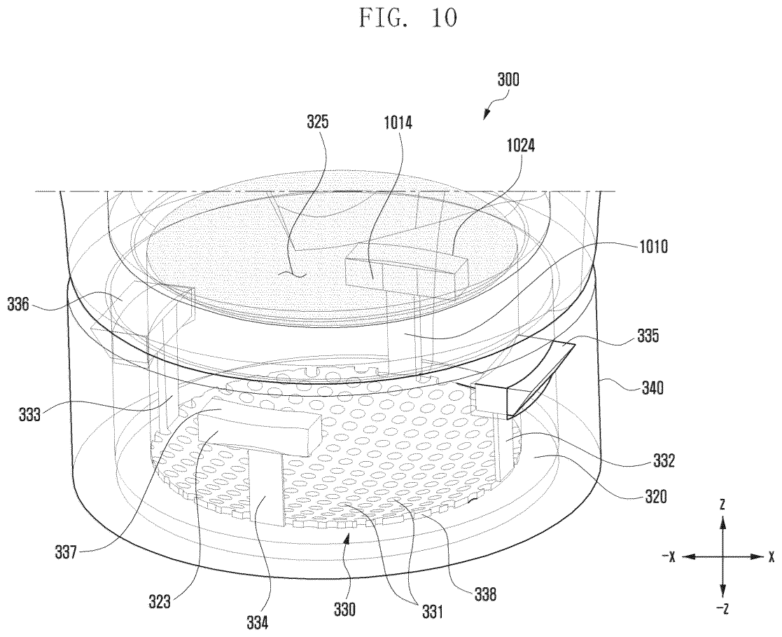

With reference to FIG. 4, the nozzle 320 may be constituted of a cylindrical shape or a pipe shape. The nozzle 320 may have the acoustic path 325 formed therein. The nozzle 320 may include a first hole 321, a second hole 322, a first concave portion 323, and/or a second concave portion (e.g., a second concave portion 1024 in FIG. 10).

According to one or more embodiments, the first hole 321 may be formed in a first position of the nozzle 320. For example, the first hole 321 may be formed at a designated position in a first direction (e.g., the x-axis direction) when the nozzle 320 is viewed from the side surface. The second hole 322 may be formed in a second position of the nozzle 320. The second position may be in an opposite direction to the first position. The second hole 322 may be formed at a designated position in the second direction (e.g., the −x-axis direction) opposite to the first direction of the nozzle 320. The first concave portion 323 may be formed at a third position (e.g., a designated position in a third direction) between the first hole 321 and the second hole 322. The second concave portion 1024 may be formed at a fourth position (e.g., a designated position in a fourth direction opposite to the third direction) between the first hole 321 and the second hole 322. The first concave portion 323 and the second concave portion 1024 may be formed in the form of a groove on an inner side surface of the nozzle 320. In an embodiment, the first hole 321 and the second hole 322 are disposed to face each other, and the first concave portion 323 and the second concave portion 1024 may be disposed to face each other.

According to an embodiment, the acoustic path 325 may be formed inside the nozzle 320. The acoustic path 325 (e.g., sound channel) may form a transmission passage for sound output from the wearable electronic device 300 and/or a transmission passage for audio (e.g., voice and/or sound) input to the wearable electronic device 300. According to one or more embodiments, the acoustic path 325 may be formed with a shape corresponding to the inside of the nozzle 320.

According to an embodiment, the grill 330 may be detachably coupled (i.e., coupled such that it may be attached and later detached or vice-versa), to an inner side of the nozzle 320. For example, the grill 330 may be inserted into the inner side of the nozzle 320 through the acoustic path 325 and may be detachably coupled to the inner side of the nozzle 320. According to one or more embodiments, the grill 330 may be constituted of a rigid material, such as plastic and/or metal.

With reference to FIG. 5, the grill 330 may include the frame 338, at least one opening 331, a first extension 332, a first latch 335, a second extension 333, a second latch 336, a third extension 334, a first coupling member 337, a fourth extension (e.g., a fourth extension 1010 in FIG. 10), and/or a second coupling member (e.g., a second coupling member 1014 in FIG. 10).

According to one or more embodiments, the third extension 334 and/or the fourth extension (e.g., the fourth extension 1010 in FIG. 10) may be constituted in the form of a latch.

According to an embodiment, the frame 338 may be disposed across one end of the nozzle 320 (e.g., in the −z-axis direction). The frame 338 may be a plate in which at least one opening 331 is formed. The at least one opening 331 (e.g., a sound hole) may be formed in the frame 338. At least one opening 331 may transmit sound output through a speaker module (e.g., the sound output module 155 in FIG. 1) disposed inside the housing 310 of the wearable electronic device 300 toward at least a part of a user's eardrum. At least one opening 331 may receive audio (e.g., a voice of a user of the wearable electronic device 300 and/or sound from the outside) and transmit the audio to a microphone hole of the microphone module (e.g., the input module 150 in FIG. 1).

According to an embodiment, the first extension 332 may extend from a first portion (e.g., the x-axis direction) of the frame 338 in the z-axis direction. The first extension 332 may include a plate having elasticity. The first latch 335 may be formed to protrude from an end (e.g., the z-axis direction) of the first extension 332 in the first direction (e.g., in the x-axis direction). The first latch 335 may be inserted and passed through the first hole 321 formed in the nozzle 320, and may protrude in the first direction (e.g., in the x-axis direction) to be detachably coupled to the first hole 321. The first latch 335 may include a first inclined surface 335a that slopes from a top (e.g., in the y1-axis direction) to a bottom (e.g., in the −y1-axis direction). The first latch 335 may be constituted of a rigid material, such as plastic and/or metal. In an embodiment, the first latch 335 may be constructed of the same material as the first extension 332, and may be constituted to extend from the first extension 332. In one or more embodiments, the first latch 335 may be constructed of a different material than the first extension 332, and may be constituted to extend from the first extension 332.

According to one or more embodiments, the second extension 333 may extend from a second portion (e.g., the −x-axis direction) of the frame 338 in the z-axis direction. The second extension 333 may include a plate having elasticity. The second latch 336 may be formed to protrude from an end (e.g., the z-axis direction) of the second extension 333 in the second direction (e.g., the −x-axis direction). The second latch 336 may be inserted and passed through the second hole 322 formed in the nozzle 320, and may protrude in the second direction (e.g., in the −x-axis direction) to be detachably coupled to the second hole 322. The second latch 336 may include a second inclined surface 336b that slopes from a top (e.g., the y2-axis direction) to a bottom (e.g., the −y2-axis direction). The second latch 336 may be constituted of a rigid material, such as plastic and/or metal. In one or more embodiments, the second latch 336 may be constructed of the same material as the second extension 333 and may be constituted to extend from the second extension 333. In one or more embodiments, the second latch 336 may be constructed of a different material than the second extension 333 and may be constituted to extend from the second extension 333.

According to one or more embodiments, the third extension 334 may extend from a third portion of the frame 338 (e.g., a part between the x-axis and −x-axis) in the z-axis direction. The third extension 334 may include a plate having elasticity. The first coupling member 337 may be formed to protrude from an end (e.g., the z-axis direction) of the third extension 334 to the outside (e.g., in the third direction). The first coupling member 337 is inserted into the first concave portion 323 formed in the nozzle 320, and may be supported by being caught within the first concave portion 323. The first coupling member 337 may be detachably coupled to the first concave portion 323. The first coupling member 337 may be constituted of a rigid material, such as plastic and/or metal. In one or more embodiments, the first coupling member 337 may be constructed of the same material as the third extension 334 and may be constituted to extend from the third extension 334. In one or more embodiments, the first coupling member 337 may be constructed of a different material than the third extension 334, and may be constituted to extend from the third extension 334.

According to one or more embodiments, the fourth extension (e.g., the fourth extension 1010 in FIG. 10) may extend from a fourth portion of the frame 338 (e.g., a part between the x-axis and −x-axis) in the z-axis direction. The fourth extension 1010 may include a plate having elasticity. The second coupling member (e.g., the second coupling member 1014 in FIG. 10) may be formed to protrude from an end (e.g., the z-axis direction) of the fourth extension 1010 to the outside (e.g., in the fourth direction). The second coupling member 1014 may be inserted into the second concave portion (e.g., the second concave portion 1024 in FIG. 10) formed in the nozzle 320 and supported by being caught within the second concave portion 1024. The second coupling member 1014 may be detachably coupled to the second concave portion 1024. The second coupling member 1014 may be constituted of a rigid material, such as plastic and/or metal. In one or more embodiments, the second coupling member 1014 may be constructed of the same material as the fourth extension 1010 and may be constituted to extend from the fourth extension 1010. In one or more embodiments, the second coupling member 1014 may be constructed of a different material than the fourth extension 1010, and may be constituted to extend from the fourth extension 1010.

With reference to FIGS. 3 and 6, the ear tip 340 may be detachably coupled to an outer surface of the nozzle 320. For example, the ear tip 340 may be supported by being caught on a part of the first latch 335 protruding through the first hole 321 of the nozzle 320 and/or a part of the second latch 336 protruding through the second hole 322 of the nozzle 320, and detachably coupled to an outer surface of the nozzle 320. At least a part of the ear tip 340 may be inserted into a user's ear (e.g., external auditory meatus) of the wearable electronic device 300, and may be in contact with an inner surface of the external auditory meatus. The ear tip 340 may be constituted of a material having elasticity (e.g., rubber or silicone). At least a part of the ear tip 340 is inserted into a user's ear (e.g., external auditory meatus) of the wearable electronic device 300, and may be deformed to conform to the shape of the external auditory meatus.

With reference to FIG. 6, the ear tip 340 may include a first groove 611, a third inclined surface 611a, a second groove 612, a fourth inclined surface 612b, a sealing member 621, and/or an insertion guide 610.

According to one or more embodiments, the first groove 611 may be formed in a first portion (e.g., in the x-axis direction) of an inner side of the ear tip 340. The first groove 611 may include the third inclined surface 611a that slopes in a downward direction (e.g., −y1) between the −x-axis and the −z-axis. When the ear tip 340 and the nozzle 320 are coupled using the grill 330, the third inclined surface 611a may be formed to face the first inclined surface 335a formed on the first latch 335. The first groove 611 may be formed as a structure that is supported by being at least partially caught on the first latch 335. In one or more embodiments, the first groove 611, the third inclined surface 611a, the first latch 335, and the first inclined surface 335a are not limited to the shapes disclosed in FIGS. 5 and 6, but may be constituted of various other shapes. For example, the third inclined surface 611a and the first inclined surface 335a may be constituted of various other shapes, as long as the first groove 611 and the first latch 335 are detachably coupled.

According to one or more embodiments, the second groove 612 may be formed on a second portion (e.g., the −x-axis direction) of an inner side of the ear tip 340. The second groove 612 may include the fourth inclined surface 612b that slopes in a downward direction (e.g., −y2) between the x-axis and the −z-axis. When the ear tip 340 and nozzle 320 are coupled using the grill 330, the fourth inclined surface 612b may be formed to face the second inclined surface 336b formed on the second latch 336. The second groove 612 may be formed as a structure that is supported by being at least partially caught on the second latch 336. In one or more embodiments, the second groove 612, the fourth inclined surface 612b, the second latch 336, and the second inclined surface 336b are not limited to the shapes disclosed in FIGS. 5 and 6, but may be constituted of various other shapes. For example, the fourth inclined surface 612b and the second inclined surface 336b may be constituted of various other shapes, as long as the second groove 612 and the second latch 336 are detachably coupled.

According to one or more embodiments, the sealing member 621 may be partially formed at an end of the ear tip 340 (e.g., in the z-axis direction). The sealing member 621 may be integrally formed with the ear tip 340. The sealing member 621 may be at least partially formed at a position where the ear tip 340 and a part of the housing 310 face each other. The sealing member 621 may prevent foreign objects, such as moisture and/or dust, from infiltrating the wearable electronic device 300 from the outside. The sealing member 621 may perform a water proof and/or dust proof function for the wearable electronic device 300. The sealing member 621 may be constituted of a material having elasticity, such as rubber or silicone. In one or more embodiments, the sealing member 621 and the ear tip 340 may be constituted of different materials. In one or more embodiments, the sealing member 621 and the ear tip 340 may be constituted of the same material.

According to one or more embodiments, the insertion guide 610 may provide a guide when the ear tip 340 and the nozzle 320 are coupled using the grill 330. The insertion guide 610 may be formed such that the ear tip 340 is attachable to or detachable from the nozzle 320. The insertion guide 610 may include a first cutting portion 341 and a second cutting portion 342. The first cutting portion 341 may be a portion in which a part of an inner side surface of the ear tip 340 in the first direction (e.g., the x-axis direction) and/or a part of the sealing member 621 is cut. The second cutting portion 342 may be a portion in which a part of an inner side surface of the ear tip 340 in the second direction (e.g., the −x-axis direction) and/or a part of the sealing member 621 is cut. In one or more embodiments, the insertion guide 610 is described as including the first cutting portion 341 and the second cutting portion 342, but the insertion guide 610 may further include other cutting portions in addition to the first cutting portion 341 and the second cutting portion 342.

According to one or more embodiments, a part of the ear tip 340 in which the first cutting portion 341 is formed (e.g., in the x-axis direction) may be formed such that a width w2 of an upper portion thereof (e.g., in the z-axis direction) is narrower than a width w1 of a lower portion thereof (e.g., in the −z-axis direction). A part of the ear tip 340 in which the second cutting portion 342 is formed (e.g., in the −x-axis direction) may be formed such that a width w2 of an upper portion thereof (e.g., in the z-axis direction) is narrower than a width w1 of a lower portion thereof (e.g., in the −z-axis direction).

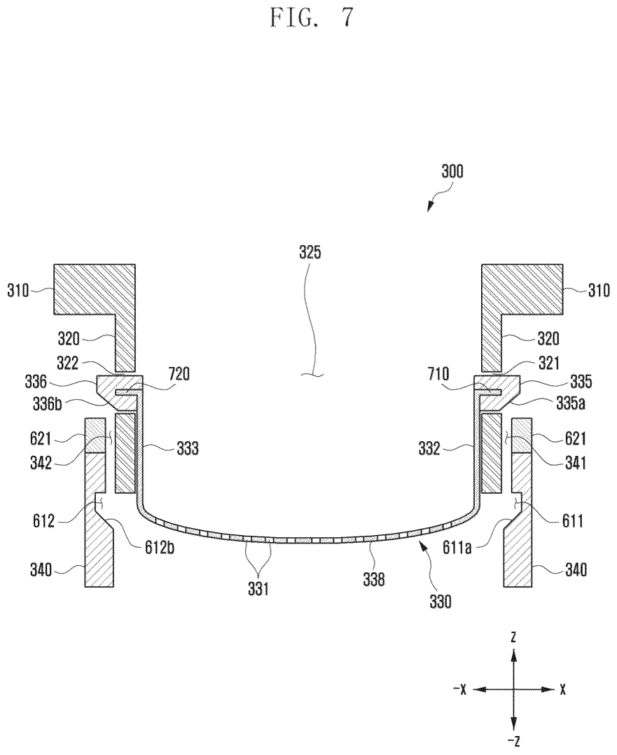

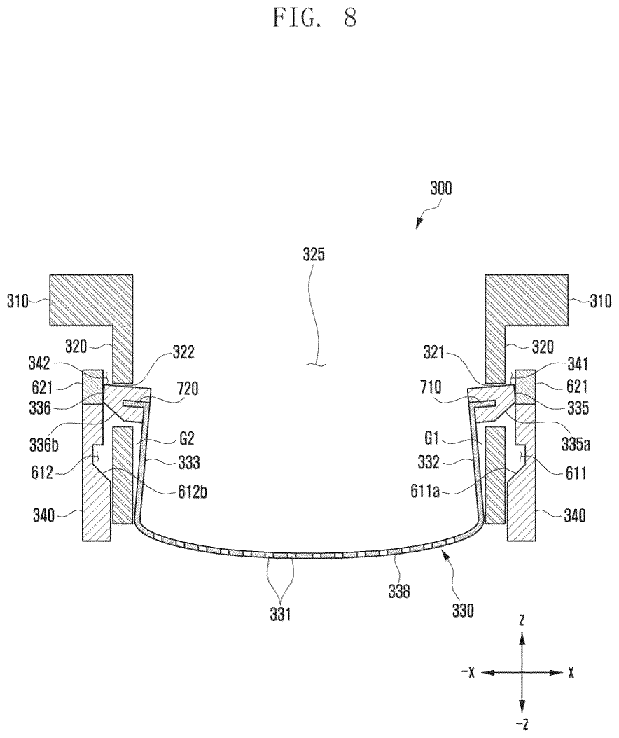

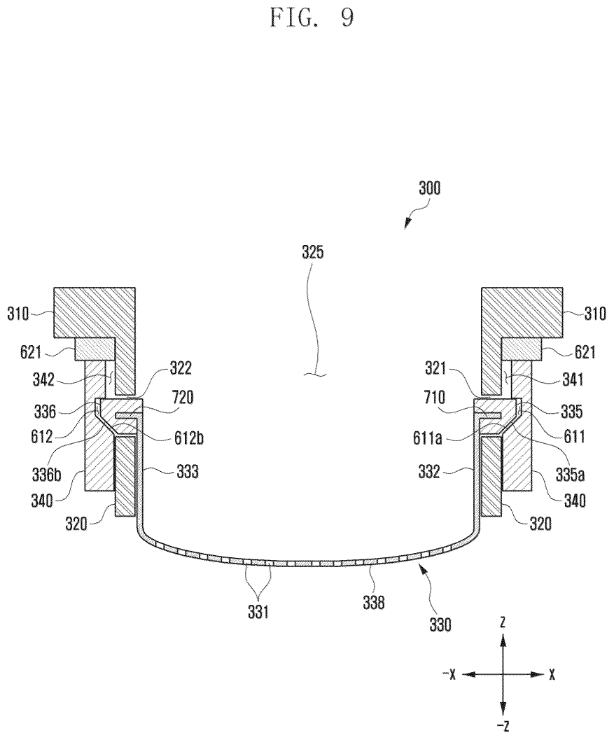

FIG. 7 is a view schematically illustrating a state before an ear tip of a wearable electronic device, according to one or more embodiments of the present disclosure, is inserted into a nozzle. FIG. 8 is a view schematically illustrating an intermediate state in which an ear tip of a wearable electronic device, according to one or more embodiments of the present disclosure, is inserted into a nozzle. FIG. 9 is a view schematically illustrating the state after an ear tip of a wearable electronic device, according to one or more embodiments of the present disclosure, has been inserted into a nozzle.

With reference to FIG. 7, in the wearable electronic device 300 according to one or more embodiments of the present disclosure, the grill 330 may be detachably coupled to an inner side of the nozzle 320 through the acoustic path 325. The grill 330 may have at least a part of the first latch 335 passing through the first hole 321 of the nozzle 320 and protruding to the outside of the nozzle 320 (e.g., in the x-axis direction). The grill 330 may have at least a part of the second latch 336 passing through the second hole 322 of the nozzle 320 and protruding to the outside of the nozzle 320 (e.g., in the −x-axis direction).

According to one or more embodiments, the grill 330 may be constituted of the frame 338, the first extension 332, and the second extension 333 being integrally connected, for example, in a U-shape. The first extension 332 extending from the first portion (e.g., the x-axis direction) of the frame 338 in the z-axis direction and the second extension 333 extending from the second portion (e.g., the −x-axis direction) of the frame 338 in the z-axis direction may have elasticity. For example, the first extension 332 extending from the first portion (e.g., the x-axis direction) of the frame 338 in the z-axis direction may be bent by an external force (e.g., the ear tip 340) in the −x-axis direction or restored to its original position. The second extension 333 extending from the second portion (e.g., the −x-axis direction) of the frame 338 in the z-axis direction may be bent by an external force (e.g., the ear tip 340) in the x-axis direction or restored to its original position.

According to one or more embodiments, the first extension 332 may include a first end 710, such that an end of the first extension 332 in the z-axis direction extends in the first direction (e.g., in the x-axis direction). The first end 710 may include the first latch 335. The first latch 335 may be a first cap constituted of rubber or silicone of a flexible material. The second extension 333 may include a second end 720, such that an end of the second extension 333 in the z-axis direction extends in the second direction (e.g., in the −x-axis direction). The second end 720 may include the second latch 336. The second latch 336 may be a second cap constituted of rubber or silicone of a flexible material.

With reference to FIG. 8, in the wearable electronic device 300 according to one or more embodiments of the present disclosure, an inner peripheral surface of the ear tip 340 may move in the z-axis direction along an outer peripheral surface of the nozzle 320. In response to the movement, when at least a part of the ear tip 340 compresses at least a part of the first latch 335 protruding through the first hole 321 of the nozzle 320 and at least a part of the second latch 336 protruding through the second hole 322 of the nozzle 320, the first extension 332 of the grill 330 may be bent in the −x-axis direction away from the inner side surface of the nozzle 320 to have a first gap G1, and the second extension 333 may be bent in the x-axis direction away from the inner side surface of the nozzle 320 to have a second gap G2.

With reference to FIG. 9, in the wearable electronic device 300 according to one or more embodiments of the present disclosure, when the inner peripheral surface of the ear tip 340 moves in the z-axis direction along the outer peripheral surface of the nozzle 320, the third inclined surface 611a formed in the first groove 611 of the ear tip 340 slides along the first inclined surface 335a formed in the first latch 335 of the grill 330, and the fourth inclined surface 612b formed in the second groove 612 of the ear tip 340 may slide along the second inclined surface 336b formed in the second latch 336 of the grill 330. In response to the sliding, the first latch 335 may be at least partially supported by being caught in the first groove 611, and the second latch 336 may be at least partially supported by being caught in the second groove 612. In one or more embodiments, the first latch 335 may be detachably coupled to the first groove 611 and the second latch 336 may be detachably coupled to the second groove 612.

According to one or more embodiments, when the ear tip 340 and the nozzle 320 are coupled, the first extension 332 of the grill 330 may be restored in the x-axis direction to be adjacent to the inner side surface of the nozzle 320, and the second extension 333 may be restored in the −x-axis direction to be adjacent to the inner side surface of the nozzle 320. When the ear tip 340 and the nozzle 320 are coupled, the sealing member 621 formed at an end of the ear tip 340 (e.g., in the z-axis direction) may be pressed through the housing 310.

FIG. 10 is a view schematically illustrating a state in which a grill, a nozzle, and an ear tip of a wearable electronic device, according to one or more embodiments of the present disclosure, are coupled together.

According to one or more embodiments, as illustrated in FIGS. 7 to 9, when the ear tip 340 moves in the z-axis direction along the outer peripheral surface of the nozzle 320, at least a part of the first latch 335 of the grill 330 that has passed through the first hole 321 of the nozzle 320 is coupled to the first groove 611 formed in the ear tip 340, and at least a part of the second latch 336 of the grill 330 that has passed through the second hole 322 of the nozzle 320 may be coupled to the second groove 612 formed in the ear tip 340.

According to one or more embodiments, when the inner peripheral surface of the ear tip 340 moves along the outer peripheral surface of the nozzle 320 in the z-axis direction, the first coupling member 337 (e.g., a first convex portion) formed to protrude from an end of the third extension 334 of the grill 330 (e.g., the z-axis direction) to the outside (e.g., in the third direction) is detachably coupled to the first concave portion 323 formed on the inner side of the nozzle 320, and the second coupling member 1014 (e.g., a second convex portion) formed to protrude from an end of the fourth extension 1010 of the grill 330 (e.g., the z-axis direction) to the outside (e.g., in the fourth direction) may be detachably coupled to the second concave portion 1024 formed on the inner side of the nozzle 320. In one or more embodiments, in the wearable electronic device 300 according to one or more embodiments of the present disclosure, the coupling structure of the ear tip 340 and the nozzle 320 can be simplified using the grill 330, and a wide acoustic path can be ensured inside the nozzle 320.

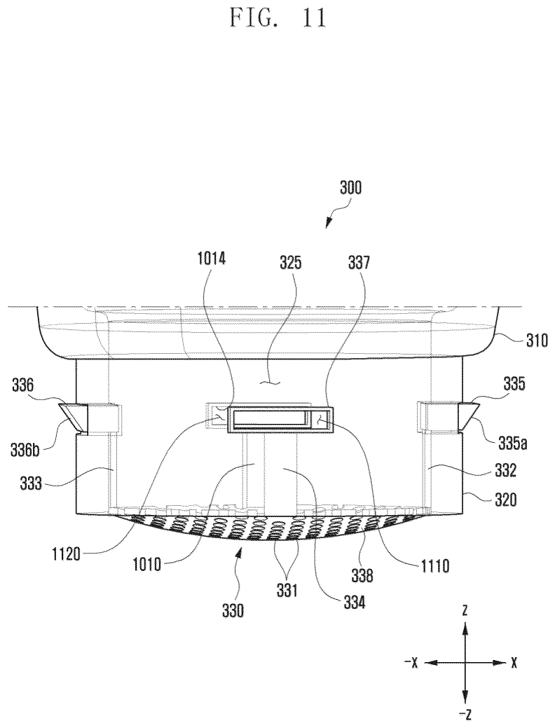

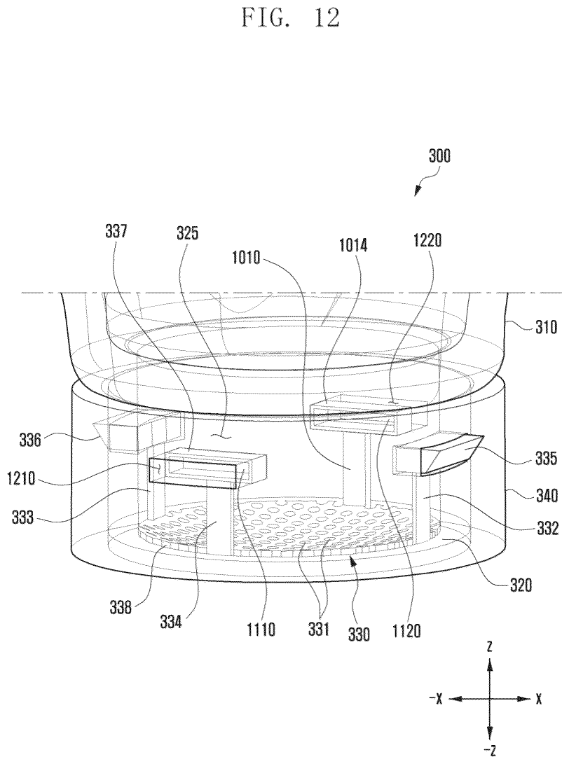

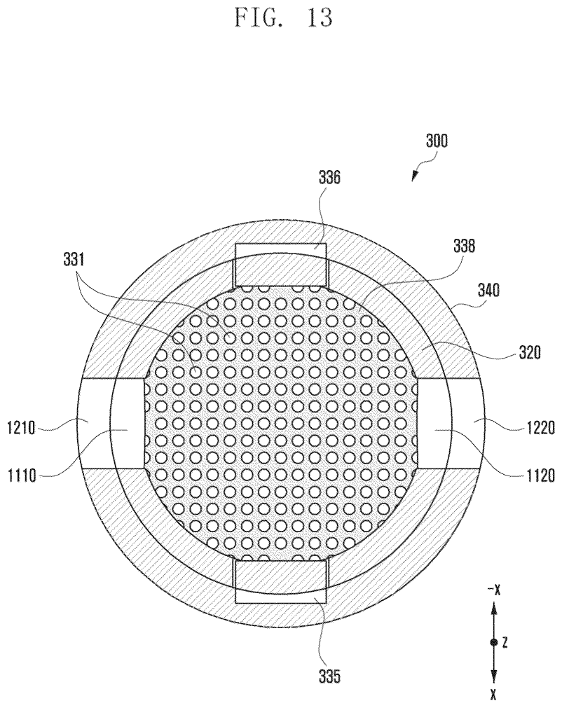

FIG. 11 is a view schematically illustrating an embodiment in which a through-hole is formed in a first coupling member and/or a second coupling member of a wearable electronic device according to one or more embodiments of the present disclosure. FIG. 12 is a view schematically illustrating an embodiment in which a through-hole is formed in an ear tip corresponding to a through-hole formed in a first coupling member and/or a second coupling member of a wearable electronic device according to one or more embodiments of the present disclosure. FIG. 13 is a view in which a portion corresponding to the through-hole of the wearable electronic device disclosed in FIG. 12 is cut in a horizontal direction and viewed from the z-axis.

In one or more embodiments, the embodiments disclosed in FIGS. 11 to 13 may be applied to and integrated with the embodiments disclosed in FIGS. 3 to 10 as described above. In one or more embodiments, FIG. 11 may be a view illustrating a state before the ear tip 340 is coupled to the nozzle 320 of the wearable electronic device 300 according to one or more embodiments of the present disclosure. In one or more embodiments, FIGS. 12 and 13 may be views illustrating a state in which the ear tip 340 is coupled to the nozzle 320 of the wearable electronic device 300 according to one or more embodiments of the present disclosure.

With reference to FIG. 11, the first coupling member 337 (e.g., the first convex portion) of the grill 330 that is coupled to the first concave portion 323 of the nozzle 320 (e.g., the first concave portion 323 in FIG. 10) may include a first through-hole 1110. The first through-hole 1110 may be formed in at least a part of the first coupling member 337. The second coupling member 1014 (e.g., the second convex portion) of the grill 330 that is coupled to the second concave portion 1024 of the nozzle 320 (e.g., the second concave portion in FIG. 10) may include a second through-hole 1120. The second through-hole 1120 may be formed in at least a part of the second coupling member 1014.

According to one or more embodiments, when the first through-hole 1110 is formed in at least a part of the first coupling member 337, the first through-hole 1110 may be formed to extend to a part of the nozzle 320 that is in a position to which the first through-hole 1110 corresponds. For example, the first through-hole 1110 may also be formed in a part of the nozzle 320 to which the first through-hole 1110 corresponds. When the second through-hole 1120 is formed in at least a part of the second coupling member 1014, the second through-hole 1120 may be formed to extend to a part of the nozzle 320 that is in a position to which the second through-hole 1120 corresponds. For example, the second through-hole 1120 may also be formed in a part of the nozzle 320 to which the second through-hole 1120 corresponds. In one or more embodiments, although it is described that the first through-hole 1110 is formed in at least a part of the first coupling member 337 and the second through-hole 1120 is formed in at least a part of the second coupling member 1014, a through-hole may be formed in only one of the first coupling member 337 or the second coupling member 1014.

With reference to FIGS. 12 and 13, a third through-hole 1210 may be formed in a part of the ear tip 340 corresponding to the first through-hole 1110 formed in at least a part of the first coupling member 337. The first through-hole 1110 and the third through-hole 1210 may be in communication with the acoustic path 325. A fourth through-hole 1220 may be formed in a part of the ear tip 340 corresponding to the second through-hole 1120 formed in at least a part of the second coupling member 1014. The second through-hole 1120 and the fourth through-hole 1220 may be in communication with the acoustic path 325.

According to one or more embodiments, the first through-hole 1110 and the third through-hole 1210 and/or the second through-hole 1120 and the fourth through-hole 1220 may regulate air pressure in the wearable electronic device 300 and the external auditory meatus. The first through-hole 1110 and the third through-hole 1210 and/or the second through-hole 1120 and the fourth through-hole 1220 may tune sound output from the wearable electronic device 300. For example, the first through-hole 1110 and the third through-hole 1210 and/or the second through-hole 1120 and the fourth through-hole 1220 may improve the performance of high-bandwidth sound output from the wearable electronic device 300.

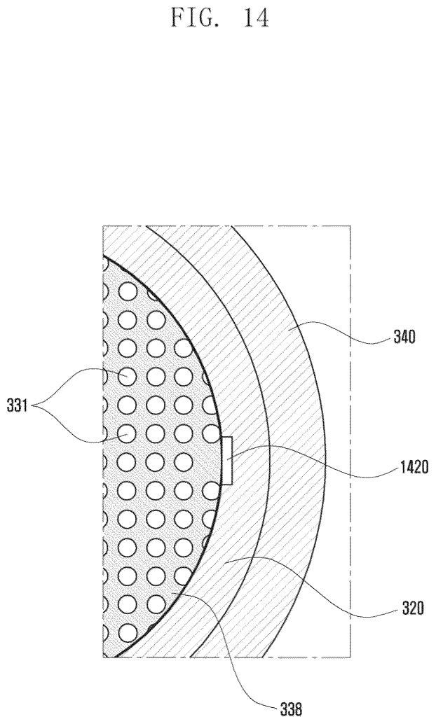

FIG. 14 is a view schematically illustrating an example of a guide groove formed on an inner side of a nozzle of a wearable electronic device according to one or more embodiments of the present disclosure.

With reference to FIG. 14, the wearable electronic device 300 according to one or more embodiments of the present disclosure may have at least one guide groove 1420 formed in at least a part of the inner side of the nozzle 320. For example, the guide groove 1420 may form a passage through which the first extension 332 and the first latch 335 of the grill 330 are guided along the inner side of the nozzle 320.

According to one or more embodiments, at least one guide grooves 1420 may be formed along the inner side of the nozzle 320 such that at least one of the first extension 332 and the first latch 335, the second extension 333 and the second latch 336, the third extension 334 and the first coupling member 337, or the fourth extension 1010 and the second coupling member 1014 of the grill 330 is guided. As the at least one guide groove 1420 is formed on the inner side of the nozzle 320, the width of the nozzle 320 may be formed wider and the acoustic path 325 may be further extended.

The wearable electronic device 300 according to one or more embodiments of the present disclosure may include a housing 310 forming at least a part of an exterior appearance thereof, a nozzle 320 extending in a designated direction (e.g., in the −z-axis direction) from a part of the housing and including a first hole 321 formed at a first position (e.g., the x-axis direction) and a second hole 322 formed at a second position (e.g., the −x-axis direction), an acoustic path 325 formed inside the nozzle, a grill 330 inserted into an inside of the nozzle through the acoustic path and including a first latch 335 passing through the first hole 321 such that a part thereof protrudes in a first direction (e.g., in the x-axis direction) and a second latch 336 passing through the second hole 322 such that a part thereof protrudes in a second direction (e.g., the −x-axis direction), and an ear tip 340 inserted into an outer surface of the nozzle and including a first groove 611 detachably coupled to a part of the first latch and a second groove 612 detachably coupled to a part of the second latch.

While the present disclosure has been described above with reference to one or more embodiments of the present disclosure, it is apparent that the alterations and modifications may be made by those skilled in the art without departing from the technical spirit of the present disclosure and belong to the present disclosure.

The electronic device according to one or more embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that one or more embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with one or more embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

What is claimed is:

1. A wearable electronic device comprising:
a housing forming at least a part of an exterior of the wearable electronic device;
a nozzle extending from a part of the housing, wherein the nozzle comprises a first hole at a first position and a second hole at a second position;
an acoustic path inside the nozzle;
a grill inside the nozzle, wherein the grill comprises a first latch passing through the first hole such that a part thereof protrudes in a first direction and a second latch passing through the second hole such that a part thereof protrudes in a second direction; and
an ear tip at least partially surrounding an outer surface of the nozzle, wherein the ear tip comprises a first groove detachably coupled to a part of the first latch and a second groove detachably coupled to a part of the second latch.

2. The wearable electronic device of claim 1,
wherein the nozzle further comprises a first concave portion at a third position between the first hole and the second hole and a second concave portion at a fourth position between the first hole and the second hole, and
wherein the grill further comprises a first coupling member detachably coupled to the first concave portion and a second coupling member detachably coupled to the second concave portion.

3. The wearable electronic device of claim 2,
wherein the first hole and the second hole face each other, and
wherein the first concave portion and the second concave portion face each other.

4. The wearable electronic device of claim 2, wherein the first coupling member comprises a first through-hole, and the second coupling member comprises a second through-hole.

5. The wearable electronic device of claim 4, wherein the ear tip comprises a third through-hole in a part of the ear tip corresponding to the first through-hole, and a fourth through-hole in a part of the ear tip corresponding to the second through-hole.

6. The wearable electronic device of claim 5, wherein the first through-hole, the second through-hole, the third through-hole, and the fourth through-hole are in communication with the acoustic path.

7. The wearable electronic device of claim 2, wherein the grill further comprises:
a frame disposed across one end of the nozzle and comprising at least one opening;
a first extension extending from a first portion of the frame and integrally connected to the first latch; and
a second extension extending from a second portion of the frame and integrally connected to the second latch.

8. The wearable electronic device of claim 7, wherein the grill further comprises:
a third extension extending from a third portion of the frame and integrally connected to the first coupling member; and
a fourth extension extending from a fourth portion of the frame and integrally connected to the second coupling member.

9. The wearable electronic device of claim 1,
wherein the first latch comprises a first inclined surface, the second latch comprises a second inclined surface, the first groove comprises a third inclined surface, and the second groove comprises a fourth inclined surface, and
wherein the first latch is at least partially coupled to the first groove, and the second latch is at least partially coupled to the second groove.

10. The wearable electronic device of claim 1, wherein a sealing member is partially formed at an end of the ear tip that faces a part of the housing.

11. The wearable electronic device of claim 1, wherein an insertion guide is formed on a part of an inner side of the ear tip.

12. The wearable electronic device of claim 11, wherein the insertion guide comprises a first cutting portion on a part of an inner side surface of the ear tip in the first direction and a second cutting portion on a part of the inner side surface of the ear tip in the second direction.

13. The wearable electronic device of claim 12, wherein the part of the ear tip on which the first cutting portion is formed comprises an upper portion having a width that is narrower than a width of a lower portion of the part of the ear tip on which the first cutting portion is formed.

14. The wearable electronic device of claim 7, wherein the first extension is bent toward an inner side of the frame when the first latch is under pressure from the ear tip and is restored to an original position when the first latch is not under pressure from the ear tip, and the second extension is bent toward the inner side of the frame when the second latch is under pressure from the ear tip and is restored to an original position when the second latch is not under pressure from the ear tip.

15. The wearable electronic device of claim 1, wherein at least one guide groove is formed on the inner side of the nozzle, and the at least one guide groove is configured to guide a part of the grill to be inserted into the nozzle.

16. A wearable electronic device comprising:
a housing forming at least a part of an exterior of the wearable electronic device;
a nozzle extending from a part of the housing, wherein the nozzle comprises a hole in a side surface of the nozzle;
a grill inside the nozzle, wherein the grill comprises a latch passing through the hole such that a part thereof protrudes out of the nozzle through the hole; and
an ear tip at least partially surrounding an outer surface of the nozzle, wherein the ear tip comprises a groove coupled to a part of the latch.

17. The wearable electronic device of claim 16, wherein the nozzle is configured to receive the grill through an acoustic path formed by an interior of the nozzle during assembly of the wearable electronic device.

18. The wearable electronic device of claim 16, wherein the ear tip is configured to alternately attach or detach from the nozzle.

19. The wearable electronic device of claim 16, wherein the grill further comprises:
a frame disposed across one end of the nozzle and comprising at least one opening; and
a first extension extending from the frame and integrally connected to the latch.

20. The wearable electronic device of claim 16, wherein a sealing member is partially formed at an end of the ear tip that faces a part of the housing.
